(19) United States
(12) Patent Application Publication
(10) Pub. No.: US 2026/0085618 A1
(43) Pub. Date: Mar. 26, 2026

(54) CONTROL DEVICE FOR A TURBINE

(71) Applicant: BorgWarner Inc., Auburn Hills, MI (US)

(72) Inventor: Frank Schmitt, Mainz (DE)

(21) Appl. No.: 19/337,840

(22) Filed: Sep. 23, 2025

(30) Foreign Application Priority Data
Sep. 24, 2024 (DE) 10 2024 127 618.5

(51) Int. Cl. F01D 17/16; F02B 37/22

(52) U.S. Cl. CPC F01D 17/16; F02B 37/22; F05D 2220/40

(57) ABSTRACT

A guide device (100) for a turbine (10), including vane bearing ring (110), a cover disk (150) which is arranged parallel to the vane bearing ring (110) and spaced apart therefrom in the axial direction (22) by spacer elements (160), and a plurality of adjustable guide vanes (120) which are each mounted rotatably and adjustably in the vane bearing ring (110). The vane bearing ring (110) and/or the cover disk (150) has/have a bevel (200, 200a, 200b) The adjustable guide vanes (120) each have a guide vane trailing edge (123). In the case of guide vane positions corresponding to a mass throughput range from a first mass throughput value to a second mass throughput value, the guide vane trailing edge (123) lies in the radial direction (24) in the region of the bevel (200, 200a, 200b), the first mass throughput value being at most 35%.

### TECHNICAL FIELD

The present invention relates to a guide device, in particular a variable turbine geometry, to a turbine for a supercharging apparatus having such a guide device, and to a supercharging apparatus for an internal combustion engine or a fuel cell having such a turbine.

### BACKGROUND

Ever-increasing numbers of vehicles of the newer generation are being equipped with supercharging apparatuses in order to achieve the required aims and satisfy legal regulations. In the development of supercharging apparatuses, it is the aim to optimize both the individual components and the system as a whole with regard to their reliability and efficiency.

Known supercharging apparatuses in most instances have at least one compressor with a compressor wheel which is connected to a drive unit via a common shaft. The compressor compresses the fresh air that is drawn in for an internal combustion engine or for a fuel cell. This increases the air or oxygen quantity that is available to the engine for combustion or to the fuel cell for reaction. This in turn leads to an increase in power of the internal combustion engine or of the fuel cell. Supercharging apparatuses may be equipped with different drive units. In particular electric chargers, in which the compressor is driven by an electric motor, and turbochargers, in which the compressor is driven by a turbine, in particular a radial turbine, are known in the prior art. In contrast to an axial turbine (as provided for example in aircraft engines), in which there is a substantially exclusively axial incident flow, it is the case in a radial turbine that the exhaust-gas flow is conducted substantially radially, and in the case of a mixed-flow radial turbine semi-radially, that is to say with at least a small axial component, from a spiral-shaped turbine inlet onto the turbine wheel. Aside from the electric charger and the turbocharger, combinations of both systems are described in the prior art, these also being referred to as E-turbos.

In order to further increase the efficiency of turbines and adapt them to different operating points, modern supercharging apparatuses are equipped with a power adjusting device, which can be used to adjust or change the power generation of the supercharging apparatus. Known power adjusting devices are, for example, guide devices such as a variable turbine geometry (VTG) or a wastegate flap (WG). A guide device, in particular a variable turbine geometry, is an adjustable guide apparatus for changing an inflow to a turbine wheel of the turbine. By changing the inflow (e.g. the flow cross section and the incident-flow angle), it is in particular possible to change the flow velocity of the exhaust-gas flow fed to the turbine wheel, which leads to a corresponding change in the power of the supercharging apparatus. Such systems are also referred to as variable guide vanes, VTG, guide grates or VTG guide grates.

Known guide devices, such as VTGs, frequently have a vane bearing ring with a multiplicity of adjustable guide vanes which are mounted in a circle in this vane bearing ring and are each adjustable from a substantially tangential position with respect to the circle into an approximately radial position or more radial position. The adjustable guide vanes are usually each coupled via adjustment levers to an adjusting ring, which is arranged coaxially with the vane bearing ring. The guide vanes can be adjusted and the inflow to the turbine wheel changed by a movement of the adjusting ring, for example a rotation in the circumferential direction. The rotation of the adjusting ring in the circumferential direction is provided by way of an actuating device. In particular, the actuating device is provided for generating control movements via the adjusting ring that are to be transferred to the guide device. The actuating device commonly has an actuator that is coupled via an adjusting shaft arrangement to the adjusting ring. For the mechanical coupling of the actuating device to the adjusting ring, an engagement of an inner lever with an actuating pin of the adjusting ring is often provided.

In known guide devices, a cover disk is often provided, which is arranged coaxially with respect to the vane bearing ring and, together with the vane bearing ring, defines a flow channel in which the guide vanes are arranged. Here, a flow channel width (i.e. an axial distance between the vane bearing ring and the cover disk) is defined by spacer elements. An axial width of the guide vanes is smaller than the flow channel width, with the result that the guide vanes are adjustable in the flow channel. In other words, an axial gap is provided between the guide vanes and the vane bearing ring or the cover disk. In order to be able to provide a high efficiency of the guide device, it is important to keep the axial gap as small as possible. On the other hand, the operation of the guide device at high temperatures can lead to thermal expansions of the components, in particular of the vane bearing ring and/or of the cover disk, which, in the case of an excessively small axial gap for certain guide vane opening positions, can lead to jamming of the vanes and consequently high adjusting forces. This can in turn lead to increased wear of the components of the guide device (e.g. at the engagement point between the adjusting lever and the adjusting ring). In addition, in known guide devices, sudden axial flow channel widening for certain guide vane positions may be present in the flow channel of the guide device to the turbine wheel, which can lead to an impaired inflow of fluid (in particular exhaust gas) to the turbine wheel. It is also possible for the flow channel, in particular the vane bearing ring and/or the cover disk, to have an excessively small radial extent (i.e. the flow channel is formed to be too small in the radial direction), with portions of the guide vanes for smaller guide vane opening positions already leaving the flow channel prematurely during operation and sudden widening of the flow channel also occurring. The above-mentioned points can lead to a reduced efficiency of the guide device during operation.

It is an object of the present invention to provide an improved guide device, in particular which provides a high efficiency over a wide operating range.

### SUMMARY OF THE INVENTION

The present invention relates to a guide device for a turbine, in particular a variable turbine geometry, as claimed in claim 1. The invention also relates to a turbine for a supercharging apparatus as claimed in claim 11 having such a guide device. In addition, the invention relates to a supercharging apparatus for an internal combustion engine or a fuel cell as claimed in claim 15 having such a turbine. The dependent claims describe advantageous refinements of the guide device and of the turbine.

According to a first aspect of the present invention, a guide device for a turbine comprises a vane bearing ring and a cover disk, the cover disk being arranged parallel to or coaxially with the vane bearing ring and spaced apart therefrom in the axial direction by spacer elements. In addition, the guide device comprises a plurality of adjustable guide vanes which are each mounted rotatably and adjustably in the vane bearing ring, the adjustable guide vanes being arranged between the cover disk and the vane bearing ring. The adjustable guide vanes are adjustable between a first guide vane position, in which the guide vanes are minimally open, and a second guide vane position, in which the guide vanes are maximally open. During operation of the guide device, the respective guide vane position is linked to a corresponding mass throughput through the guide device. In particular, the mass throughput may be 100% in the second guide vane position. The vane bearing ring and/or the cover disk have a bevel which, on a side of the vane bearing ring and/or of the cover disk facing the adjustable guide vanes, extends from an inner circumference of the vane bearing ring and/or of the cover disk in the radial direction as far as a bevel outer radius. The adjustable guide vanes each have a guide vane trailing edge. In the case of guide vane positions corresponding to a mass throughput range from a first mass throughput value to a second mass throughput value, the guide vane trailing edge lies in the radial direction in the region of the bevel. The first mass throughput value is preferably at most 35%.

In other words, this means that the bevel extends in the radial direction in such a way that, from a mass throughput value of 35%, based on a maximum mass throughput through the guide device, the guide vane trailing edge is located in the radial direction in the region of the bevel or, from this mass throughput value, moves into this region. In the guide vane positions corresponding to the mass throughput range through the guide device 100, the (in particular complete) guide vane can be located in the radial direction in the flow channel, i.e. in the region in which the cover disk and the vane bearing ring lie opposite one another in the axial direction. Consequently, in the case of guide vane positions corresponding to the described mass throughput range from the first mass throughput value to the second mass throughput value, the guide vane trailing edge can lie in the radial direction in the region of the bevel(s) and in the flow channel. In order to achieve these corresponding guide vane positions, the guide vanes are rotated about a respective axis of rotation of the guide vane, as a result of which the guide vane trailing edge changes its radial position. The “operation” of the guide device can be described with a standard combustion chamber measurement for guide devices, in particular VTGs, in which the measurement range is defined in equally large throughput parameter steps for different guide vane positions in dependence on the mass flow or mass throughput through the guide device. As a result of the bevel in the vane bearing ring and/or the cover disk in the range for certain “open” guide vane positions, an efficiency can be increased by the guide device, in particular for a certain range of “open” guide vane positions. The fact that the trailing edge of the adjustable guide vanes is located in the radial direction in the region of the bevel in the case of guide vane positions corresponding to the mass throughput range necessitates a certain radial arrangement and extent of the bevel, and of the cover disk and/or of the vane bearing ring, with respect to the guide vanes and thus the corresponding guide vane positions.

Furthermore, a continuous flow profile can be provided by the guide device according to the invention and an improved incident flow to the turbine wheel can be achieved. In addition, sudden widening or changes of a flow channel width can be prevented, since an optimized transition, for example to the turbine housing and/or the turbine wheel, can be provided by the bevel(s). Furthermore, enthalpy losses can be compensated for when the guide device is used in a turbine. When used with an internal combustion engine, better fuel consumption can be achieved. Furthermore, the bevel makes it possible to reduce or prevent jamming of the guide vanes in the case of high temperature use (and corresponding thermal expansions of the components).

In refinements, the first mass throughput value may be at most 30%, in particular at most 20%, more specifically 10%. In refinements that can be combined in any desired manner with the described first mass throughput values, the second mass throughput value may be at least 55%, more specifically at least 65%, in particular 70%. The described first and second mass throughput values result in the corresponding mass throughput ranges which are linked to respective guide vane positions and for which at least one portion of the guide vane, in particular the guide vane trailing edge, lies in the radial direction in the region of the bevel. A greater mass throughput range consequently necessitates a greater radial arrangement and extent of the bevel, and of the cover disk, of the vane bearing ring and/or of the flow channel formed by these components, with respect to the guide vanes or guide vane positions. In the case of guide vane positions corresponding to the preferred mass throughput ranges that follow, the guide vane trailing edge may lie in the radial direction in the region of the bevel (and in particular in the region of the bevel and in the flow channel):
the first mass throughput value may be 35% and the second mass throughput value may be 55%, resulting in a mass throughput range from 35% up to 55%;
the first mass throughput value may be 30% and the second mass throughput value may be 65%, resulting in a mass throughput range from 30% up to 65%;
the first mass throughput value may be 20% and the second mass throughput value may be 70%, resulting in a mass throughput range from 20% up to 70%; or
the first mass throughput value may be 10% and the second mass throughput value may be 70%, resulting in a mass throughput range from 10% up to 70%.
   However, other mass throughput ranges can also be formed by the aforementioned first and second mass throughput values.

A trailing edge radius is defined between the axial direction and the guide vane trailing edge. The trailing edge radius decreases with increasingly opening guide vanes (and thus increasingly “open” guide vane position). In the case of guide vane positions corresponding to the mass throughput range, the trailing edge radius may be equal to or smaller than the bevel outer radius. In the case of guide vane positions corresponding to the mass throughput range, the trailing edge radius may be equal to or greater than an inner circumferential radius of the vane bearing ring and/or of the cover disk. In other words, from a guide vane position corresponding to the first mass throughput value, the trailing edge radius may be equal to or smaller than the bevel outer radius. Consequently, the bevel extends in the radial direction in such a way that the guide vane trailing edge is located in the radial direction in the region of the bevel at least from the first mass throughput value. Up to a guide vane position corresponding to the second mass throughput value, the trailing edge radius may be equal to or greater than the inner circumferential radius of the vane bearing ring and/or of the cover disk. In other words, the inner circumferential radius of the vane bearing ring and/or of the cover disk is selected, or the guide vanes are arranged in the guide device, in such a way that it is only from values higher than the second mass throughput value that the guide vanes are no longer located in the radial direction completely in the flow channel (i.e. in the region in which the vane bearing ring and the cover disk lie opposite one another in the axial direction). For these guide vane positions, at least one portion, in particular of the guide vane trailing edge, is arranged radially to the inside of the corresponding (larger) inner circumferential radius. This radial extent of the vane bearing ring and/or of the cover disk makes it possible to reduce or avoid performance deficits.

The vane bearing ring and the cover disk define a flow channel in which the adjustable guide vanes are arranged. The flow channel may have a flow channel width which is measured in the axial direction between the vane bearing ring and the cover disk. The flow channel width may be constant between an outer circumference of the vane bearing ring and/or of the cover disk and the bevel outer radius. The flow channel width may increase between the bevel outer radius and the inner circumference of the vane bearing ring and/or of the cover disk. In preferred refinements, the flow channel width may increase constantly in this region. The axial width of the guide vane(s) is smaller than the flow channel width.

The adjustable guide vanes each have a guide vane axis of rotation. The bevel outer radius may be smaller than an axis of rotation radius which is measured between the axial direction and the guide vane axis of rotation. In refinements, the bevel radius may be at most 10% smaller than the axis of rotation radius.

The guide vanes are mounted at a uniform spacing in the circumferential direction in the vane bearing ring. Adjacent guide vanes may be distanced from one another in the first guide vane position. In other words, adjacent guide vanes do not contact one another in the first guide vane position. Even in the first guide vane position, a minimum mass throughput >0% can thus be provided by the guide device.

In preferred refinements, the cover disk and the vane bearing ring may have the bevel. In refinements, only the cover disk or only the vane bearing ring may comprise the bevel. That is to say, in this case, the respective other of the cover disk and of the vane bearing ring does not have the bevel. Here, the facing side of the vane bearing ring or of the cover disk that does not have the bevel may extend (in particular continuously) in the radial direction or run (in particular continuously) perpendicular to the axial direction.

In refinements, the cover disk may have an outer radius, a ratio of the bevel outer radius to the outer radius being from 0.60 to 0.85, in particular from 0.65 to 0.80. In refinements, an inner circumferential radius of the vane bearing ring may be smaller than an inner circumferential radius of the cover disk.

In refinements, the cover disk may have, on a side facing away from the adjustable guide vanes, an axial, disk-shaped extent which is arranged in a radially outer region of the cover disk. The cover disk consequently has a depression on the facing-away side in a radially inner region. In particular, the axial extent has an axial surface which serves as an axial bearing surface and for the introduction of forces during the mounting of the guide device in a turbine housing in the axial direction. In particular, the disk-shaped extent may be arranged in the radial direction in the region of the spacer elements. As a result of this arrangement, the forces transmitted to the cover disk by the spacer elements can be introduced directly axially into the turbine housing by way of the extent. This makes it possible to improve a surface pressure.

In refinements, the bevel between the inner circumference of the vane bearing ring and/or of the cover disk may run in a planar manner (or linear manner in cross section) and/or in a curved manner in the radial direction as far as the bevel outer radius. A bevel angle can be measured between the facing side (or the portion extending in the radial direction or perpendicular to the axial direction) and the bevel. In particular, in this refinement, the bevel may run in a planar manner. In refinements, a bevel angle may be from 0.5° to 5.0°. In refinements, the vane bearing ring and the cover disk may have the bevel. A first bevel angle of the bevel of the cover disk may be greater than a second bevel angle of the bevel of the vane bearing ring. In refinements, the bevel angle of the bevel may be from 1° to 4°, in particular from 2° to 3°.

In the refinements in which the vane bearing ring and the cover disk have the bevel, the bevel of the cover disk may have a first gradient and the bevel of the vane bearing ring may have a second gradient. The first gradient may be greater than the second gradient, in particular the ratio of the first gradient to the second gradient at radial positions (that is to say in the radial region of the bevels) for guide vane positions corresponding to the mass throughput range being from 2.00 to 5.00, more specifically from 3.00 to 4.00, in particular from 3.25 to 3.75.

In the refinements in which the vane bearing ring and the cover disk have the bevel, or only the cover disk has the bevel, it is possible in the radial direction in the region of the bevel(s) (or in the region of the flow channel in which the bevels of the vane bearing ring and of the cover disk lie opposite one another in the axial direction), at each radial position, for a first axial distance between the guide vane and the cover disk to be greater than a second axial distance between the guide vane and the vane bearing ring.

The bevel may extend over the entire circumference on the facing side. In other refinements, the bevel may extend only partially circumferentially. In refinements, the bevel may have at least two bevel portions, which each extend over a circumferential portion. The respective circumferential portions may be the same size. Webs which separate the circumferential portions from one another may be arranged between the respective circumferential portions. The bevel may thus be provided only in the region of certain guide vanes.

In refinements, the guide device may be a variable turbine geometry. The guide device may comprise an adjusting ring, the adjusting ring comprising a plurality of coupling regions. Each adjustable guide vane of the plurality of adjustable guide vanes may be connected to one vane lever each for conjoint rotation. In particular, each vane lever may be at least partially accommodated in a respective coupling region for adjusting the respective adjustable guide vane. The adjustable guide vane may be connected to a vane shaft at a first end of the vane shaft for conjoint rotation. The vane lever may be connected to the vane shaft at a second end of the vane shaft opposite the first end. Each vane lever may have a radial vane lever portion, which extends radially from the vane shaft, and an axial vane lever portion, which extends axially from the radial vane lever portion toward the adjusting ring. In particular, the axial vane lever portion may extend axially at least partially into the respective coupling region. The adjustable guide vanes may be mounted rotatably in the vane bearing ring by means of the vane shafts in a manner distributed in the circumferential direction. The guide device may have an odd number of adjustable guide vanes. In refinements, at least three spacer elements may be provided, which are each coupled or connected to at least the vane bearing ring at a uniform spacing in the circumferential direction. In refinements, the spacer elements may be arranged in the radial direction between the bevel outer radius and an outer radius of the cover disk and of the vane bearing ring. The respective spacer elements may be fixedly connected to the cover disk and/or the vane bearing ring. The guide device may comprise an actuating device which is operatively coupled to the adjusting ring and designed to move the adjusting ring in the circumferential direction. The actuating device may be coupled to the adjusting ring via one or more levers and/or a control rod.

According to a second aspect of the present invention, a turbine for a supercharging apparatus comprises a turbine housing, a turbine wheel which is arranged rotatably in the turbine housing, and a guide device according to the first aspect of the present invention. The guide device is arranged radially outside the turbine wheel in the turbine housing and surrounds the turbine wheel circumferentially.

In refinements, the turbine housing may have a shoulder for axially and radially mounting the cover disk. The shoulder may have a ring-shaped, axial projection which is arranged radially to the inside of the cover disk and forms a radial surface pairing with an inner circumference of the cover disk. The shoulder, in particular the projection, may have an end side. The cover disk may have the bevel, the bevel being flush with the end side of the shoulder in the axial direction at the inner circumference of the cover disk. As a result, a moderate transition between the guide device, in particular the cover disk, and the turbine housing may be provided on a side facing the guide vanes. In addition, a more uniform inflow to the turbine wheel may be provided.

The shoulder may have an axial surface and the cover disk may have an axial, disk-shaped extent which is arranged in a radially outer region of the cover disk. The axial surface of the shoulder and the axial, disk-shaped extent may form an axial surface pairing.

In refinements, the cover disk may have the bevel and an inner circumferential radius, the inner circumferential radius being equal to or greater than a turbine wheel radius. In particular, a ratio of a turbine wheel radius to the inner circumferential radius may be from 0.75 to 1.00, in particular from 0.80 to 0.98, more specifically from 0.85 to 0.95. On the basis of this refinement, a greater radial extent of the flow channel can be provided and an improved inflow to the turbine wheel can be provided.

In refinements, the turbine may comprise a clamping means, the clamping means being arranged in the axial direction between the guide device, in particular the vane bearing ring, and a turbine rear wall. The clamping means may be designed to clamp the guide device against the turbine housing in such a way that an axial force is introduced via the axial, disk-shaped extent into the turbine housing. The clamping means may abut at its radially outer end against the vane bearing ring and at its radially inner end against the turbine rear wall. In refinements, a heat shield may be clamped between the clamping means and the vane bearing ring. In refinements, the turbine rear wall may be formed as part of a bearing housing.

According to a third aspect of the present invention, a supercharging apparatus for an internal combustion engine or a fuel cell comprises a bearing housing, a shaft which is mounted rotatably in the bearing housing, a compressor with a compressor wheel, and a turbine according to the second aspect of the present invention. The turbine wheel and the compressor wheel are coupled to the shaft at opposite ends of the shaft for conjoint rotation.

In refinements, the compressor may comprise a compressor housing, in which the compressor wheel is arranged. The bearing housing may be connected to the turbine housing and the compressor housing. The supercharging apparatus may comprise an electric motor, which is arranged in an engine compartment in the bearing housing, the turbine wheel and/or the compressor wheel being coupled to the electric motor via the shaft.

The turbine and the supercharging apparatus according to the aspects of the present invention can provide the advantages described above and have the refinements described above.

### BRIEF DESCRIPTION OF THE FIGURES

FIG. 1 shows an isometric view of an exemplary supercharging apparatus with a turbine and a compressor;

FIG. 2 shows a sectional view of the turbine with a guide device according to aspects of the present invention;

FIGS. 3A to 3C show detailed sectional views of the turbine and of the guide device from FIG. 2;

FIGS. 4A and 4B show a perspective view and an exploded view of the guide device;

FIGS. 5A to 5C show sectional views and a plan view of a cover disk of the guide device;

FIGS. 6A and 6B show a sectional view through the guide device of FIGS. 2 to 4B (cut through the guide vanes in the flow channel and in plan view of the cover disk), the guide vanes of the guide device being in different guide vane positions;

FIGS. 7A and 7B show a sectional view through the guide device of FIGS. 2 to 4B (cut through the guide vanes in the flow channel and in plan view of the vane bearing ring);

FIGS. 8A to 9H schematically show, for the guide device of FIGS. 2 to 7B, different radial positions of the guide vane trailing edge with respect to the bevel(s) for different guide vane positions corresponding to the mass throughput range;

FIG. 10 shows a diagram in which the efficiency is plotted against the mass throughput for different guide vane positions of the guide device according to the invention, compared with a conventional guide device.

### DETAILED DESCRIPTION

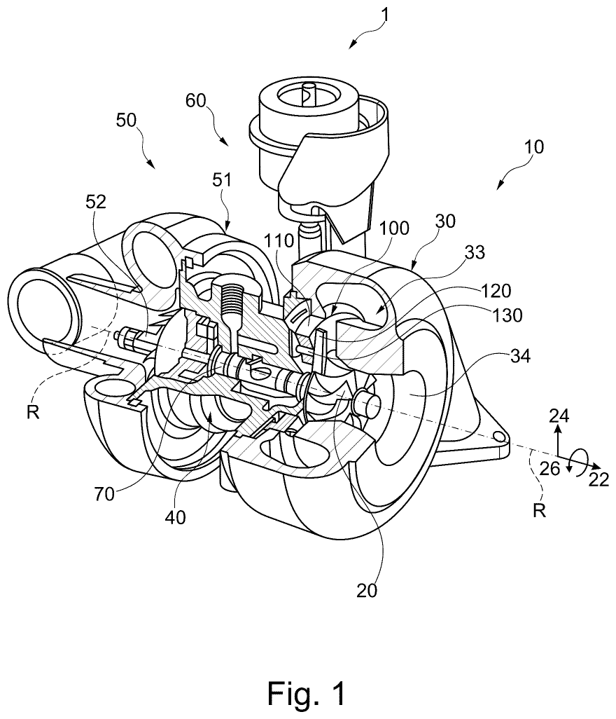

In the context of this application, the expressions “axially” and “axial direction” refer to an axis of rotation R of the shaft 70 or the turbine wheel 20, the axis of rotation R of the turbine 10 and/or the guide device 100. With reference to the figures (see e.g. FIGS. 1 to 9H), the axial direction is represented by the reference sign 22. The axial direction 22 runs in the direction of the axis of rotation R. A radial direction 24 refers here to the axial direction 22. Likewise, a circumference or a circumferential direction 26 refers here to the axial direction 22. The directions 22 and 24 run orthogonally to each other.

FIG. 1 shows an exemplary supercharging apparatus 1. The supercharging apparatus 1 can be used, and/or correspondingly configured or dimensioned, for an internal combustion engine or a fuel cell.

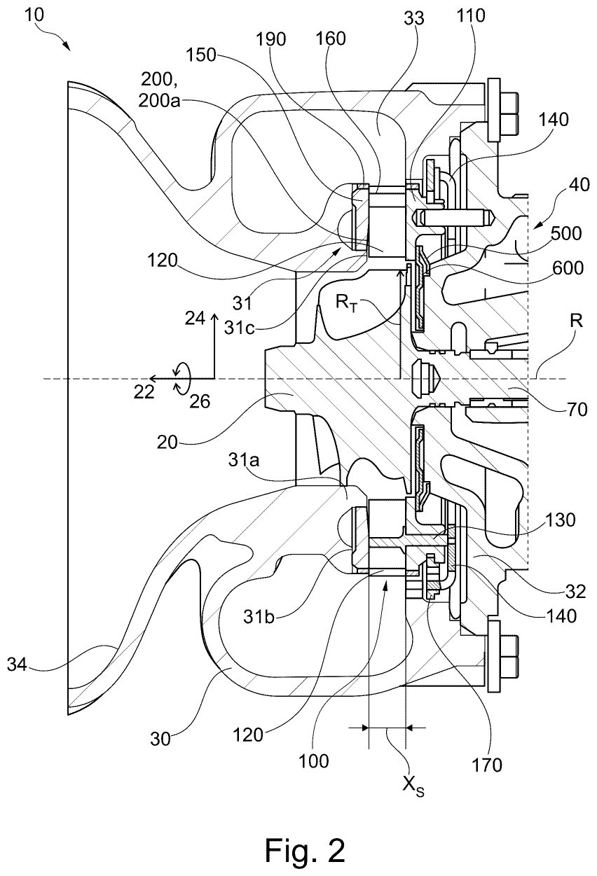

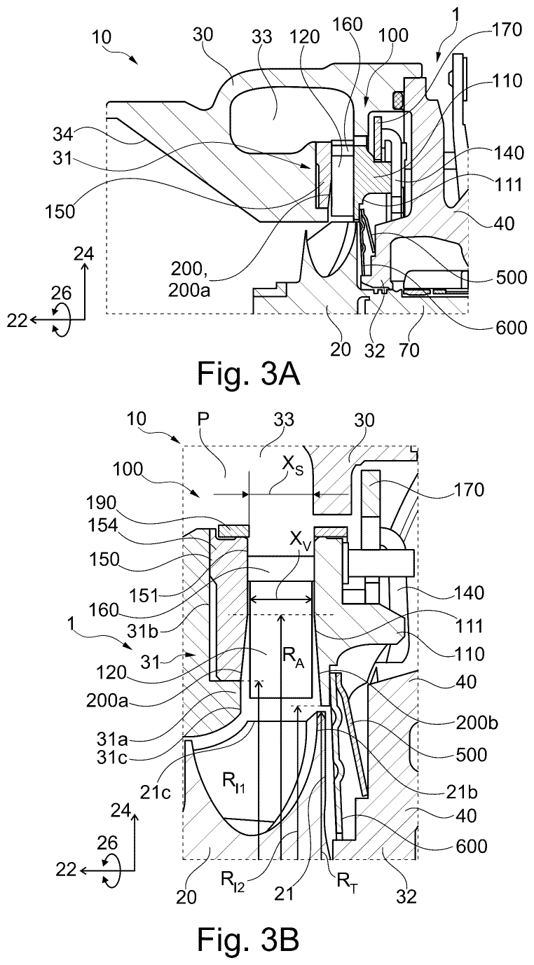

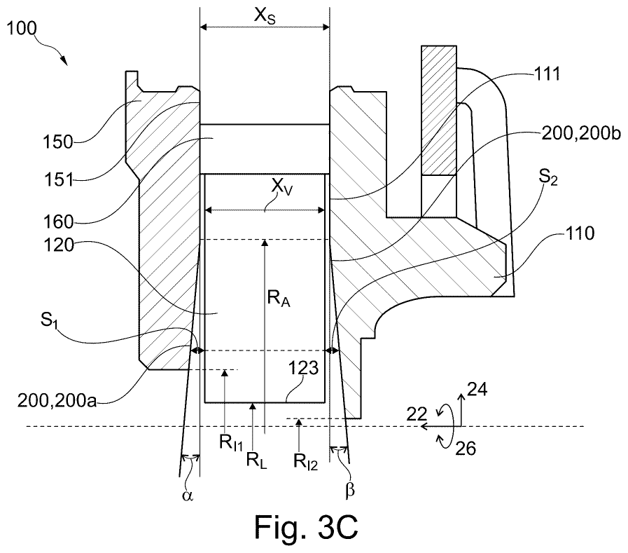

As illustrated in FIG. 1, the supercharging apparatus 1 comprises a turbine 10, a bearing housing 40 and a compressor 50. As shown in FIG. 1, the supercharging apparatus 1 can comprise an actuating device 60. The supercharging apparatus 1 may be a turbocharger here. In refinements, the supercharging apparatus 1 can also be in the form of an E-turbo (not shown in the figs.). The turbine 10 comprises a turbine housing 30 in which a turbine wheel 20 is arranged. The turbine 10 can be a radial turbine in particular. The turbine housing 30 comprises a turbine inlet 33, a turbine outlet 34 and a receiving chamber, which is arranged between the turbine inlet 33 and the turbine outlet 34 and is fluidically connected to the turbine inlet 33 and the turbine outlet 34. The turbine wheel 20 is arranged in the receiving chamber. The turbine 10 also comprises a turbine rear wall 32, which is coupled to the turbine housing 30 on the bearing housing side. As can be seen in FIGS. 2, 3A and 3B, the turbine rear wall 32 can be formed as a part of the bearing housing 40. With reference to FIG. 1, the supercharging apparatus 1 further comprises a shaft 70 with an axis of rotation R, which is rotatably coupled to the turbine wheel 20. The shaft 70 is mounted rotatably in the bearing housing 40. The axial direction 22 is defined here with respect to the axis of rotation R. As shown in FIG. 1, the compressor 50 comprises a compressor housing 51, in which a compressor wheel 52 is arranged. The bearing housing 40 is coupled (or connected) to the turbine housing 30. The bearing housing 40 is coupled (or connected) to the compressor housing 51. The compressor wheel 52 is coupled to the shaft 30 on an end of the shaft 30 opposite the turbine wheel 12 for rotation with said shaft. As can be seen in FIG. 1, the turbine 10 comprises a guide device 100, in particular a variable turbine geometry, which is explained in detail further below.

In addition to the guide device 100, the turbine 10 (not shown in the figs.) can comprise a power adjusting apparatus in the form of a wastegate flap, which is provided to be able to close and open a wastegate of the turbine 10 when required. The wastegate flap can be connected here to the actuating device 60 via a lever and/or a control rod.

In refinements, the supercharging apparatus 1 can further comprise an electric motor (not shown in the figs.), which can be arranged in an engine compartment in the bearing housing 40. The turbine wheel 20 and/or the compressor wheel 52 can be coupled here to the electric motor via the shaft 70. The electric motor can comprise a rotor and a stator, in particular wherein the rotor can be arranged on the shaft 30, and wherein the stator surrounds the rotor. Furthermore, a power electronics circuit for controlling the electric motor can be arranged in a receiving chamber in the bearing housing 40. The electric motor may also comprise a generator mode.

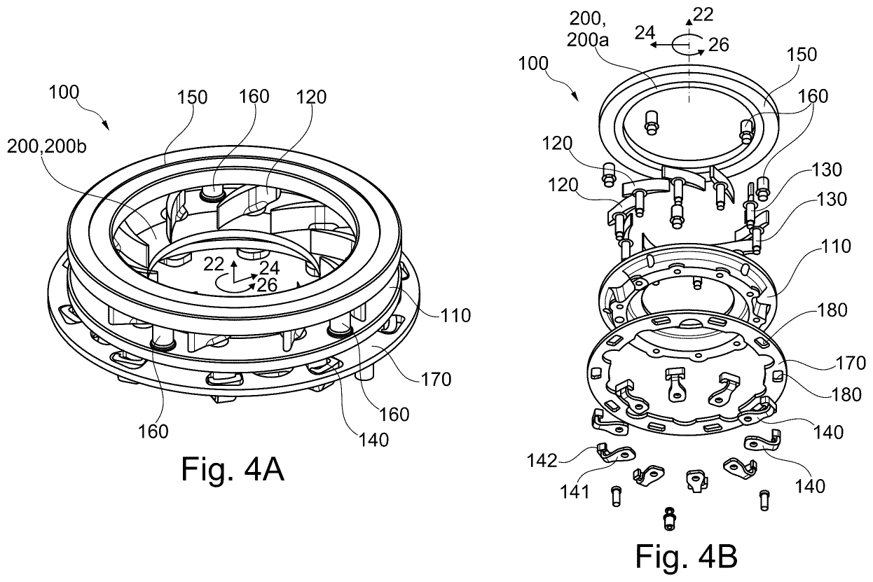

FIG. 2 shows a first sectional view of the turbine 10 with a guide device 100 according to the invention, in particular a variable turbine geometry. FIGS. 3A to 3B show more detailed sectional views of the turbine 10 from FIG. 2. FIGS. 3C, 4A and 4B show a sectional view, a perspective view and an exploded view of a guide device 100 according to the invention. The guide device 100 is provided for changing an inflow to the turbine wheel 20. The guide device 100 is arranged radially outside the turbine wheel 20, in particular the guide device 100 circumferentially surrounding the turbine wheel 20. In this case, the guide device 100 can be provided as a cartridge, which is mounted in the turbine housing 30. In particular, the guide device 100 can be pre-assembled as a cartridge and mounted via at least three pins evenly spaced apart in the circumferential direction 26 on the turbine housing rear wall 32, in particular on the bearing housing 40. The pins can be connected here to the guide device 100 and the turbine housing rear wall 32 via a press-fit connection.

As shown in FIGS. 2 to 4B and 7A to 9H, the guide device 100 comprises a vane bearing ring 110. In addition, the guide device 100 comprises a cover disk 150 which is arranged parallel to or coaxially with the vane bearing ring 110 and spaced apart therefrom in the axial direction 22 by spacer elements 160. In particular, the guide device 100 comprises a plurality of spacer elements 160, which are distributed in the circumferential direction 26 on the vane bearing ring 110 in such a way that they define an axial distance or a flow channel width X_{S} of the vane bearing ring 110 with respect to the cover disk 150 (see FIG. 3B). In particular, the plurality of spacer elements 160 can comprise at least three spacer elements. The guide device 100 comprises a plurality of adjustable guide vanes 120 which are each mounted rotatably and adjustably in the vane bearing ring 110. The adjustable guide vanes 120 are arranged between the cover disk 150 and the vane bearing ring 110. A minimum clearance for the adjustment of the guide vanes 120 can be ensured by the spacer elements 160. In refinements, the spacer elements 160 can be arranged in the radial direction 24 between a bevel outer radius R_{A} and an outer radius R_{D}, R_{S} of the cover disk 150 and/or of the vane bearing ring 110. The respective spacer elements 160 can be fixedly connected to the cover disk 150 and/or the vane bearing ring 110.

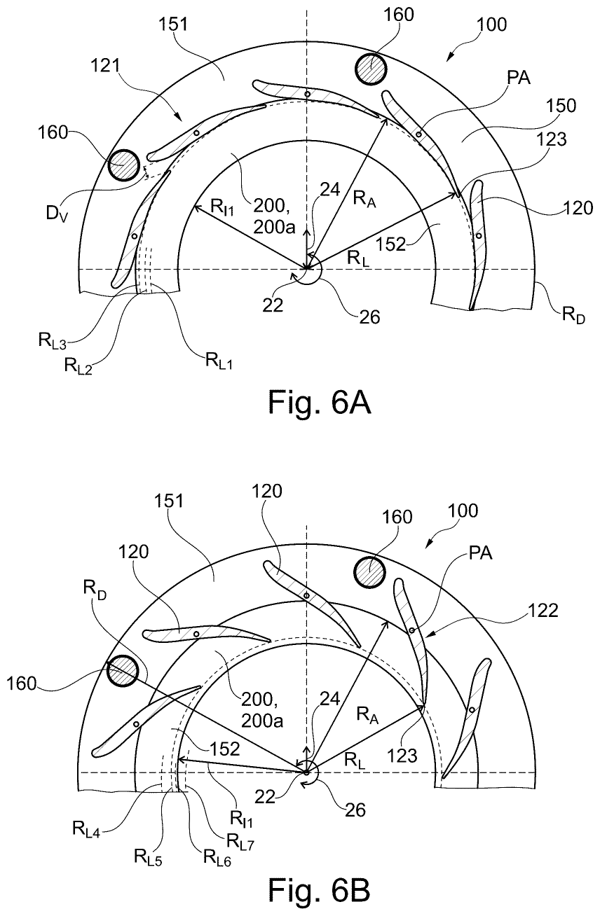

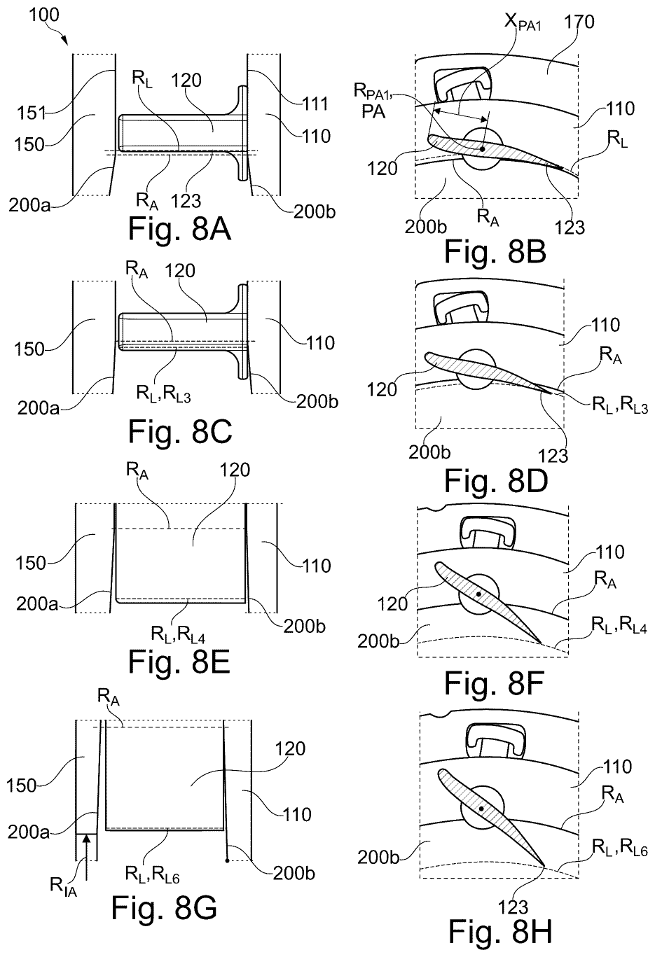

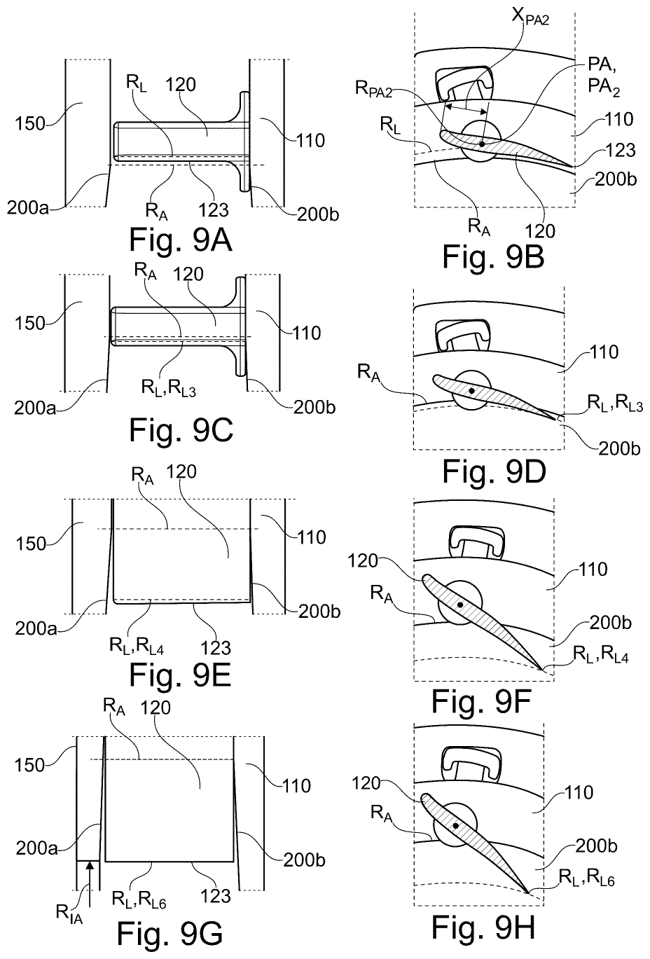

FIGS. 6A to 9H illustrate the guide vanes 120 in different guide vane positions. The guide vanes 120 are adjustable between a first guide vane position (see e.g. FIGS. 8B, 9B), and a second guide vane position (see e.g. FIG. 3C). In the first guide vane position, the guide vanes are minimally open (a “minimally open position” of the guide vanes). In the second guide vane position, the guide vanes are maximally open (a “maximally open position” of the guide vanes). A plurality of intermediate positions 121, 122 can be set between the first guide vane position and the second (see e.g. FIGS. 6A and 6B). By this means, a fluid flow from the turbine inlet 33 can be variably guided through a flow channel, i.e. where the guide vanes 120 are arranged, to the turbine wheel 20. Formed between adjacent guide vanes 120 are nozzle cross sections D_{V} (also called intermediate channel) which are larger or smaller depending on the current position of the guide vanes 120, and accordingly apply a greater or lesser amount of fluid of an internal combustion engine (e.g. exhaust gas) or of a fuel cell to the turbine wheel 20 mounted on the axis of rotation R in order, for example via the turbine wheel 20, to drive a compressor wheel 52 seated on the same shaft 70. The guide vanes 120 can be mounted at a uniform spacing in the circumferential direction 26 in the vane bearing ring 110. During operation of the guide device 100, the respective guide vane position is linked to a corresponding mass throughput through the guide device 100. In particular, in the case of the second guide vane position, the mass throughput can be 100%. Even in the first guide vane position, a minimum mass throughput >0% can be provided by the guide device 100. More precisely, a mass throughput can be provided by the guide device 100 in the first guide vane position, since respective nozzle cross sections D_{V} are still provided between the guide vanes 120. The guide vanes 120 can thus be mounted at a uniform spacing in the circumferential direction 26 in the vane bearing ring 110, and adjacent guide vanes 120 can be distanced from one another in the first guide vane position. In other words, adjacent guide vanes 120 do not contact one another in the first guide vane position.

The guide vanes each have a guide vane leading edge (or an incident-flow edge) and a guide vane trailing edge 123 (or an outflow edge). The guide vane leading edge can be understood as an incident-flow region of the guide vane 120 at maximum distance from the guide vane axis of rotation PA. The guide vane trailing edge can be understood as an outflow region of the guide vane 120 at maximum distance from the guide vane axis of rotation PA. In other words, the vane trailing edge is located downstream of the vane leading edge as seen in a flow direction along the guide vane 120. A position of the guide vanes 120 may also be referred to as a position or operating position. This includes every possible position of a guide vane 120 during the operation of the turbine 10 between the first guide vane position (at minimum passage/flow cross section) and the second guide vane position (at maximum passage/flow cross section). Every “possible position” can be understood as the position that can be provided during operation. A person skilled in the art knows that the operating positions change variably and automatically during the operation of the turbine 10 with the guide device 100 or the variable turbine geometry. In order to control the movement or the position of the guide vanes 120, an actuating device 60 as described above can be provided, which can be designed as desired per se, for example can be electronic or pneumatic, to name just a few examples. The actuating device 60 may be an actuator. In the example of FIG. 1, the actuating device 60 is designed to be pneumatic with a control housing (for example a pressure capsule) and a plunger element that transmits the movement of the control housing via one or more intermediate elements, in particular via an adjusting shaft arrangement, to the guide device 100 or to the guide vanes 120.

As shown in FIGS. 2 to 9H, the vane bearing ring 110 and/or the cover disk 150 have a bevel 200, 200a, 200b. Here, the bevel 200, 200a, 200b extends, on a side 111, 151 of the vane bearing ring 110 and/or of the cover disk 150 facing the adjustable guide vanes, from an inner circumference 112, 152 of the vane bearing ring 110 and/or of the cover disk 150 in the radial direction 24 as far as a bevel outer radius R_{A}. In preferred refinements, the cover disk 150 and the vane bearing ring 110 may have the bevel 200a, 200b. In refinements, alternatively, only the cover disk 150 or only the vane bearing ring 110 may have the bevel 200a, 200b. That is to say, in this case, the respective other of the cover disk 150 and of the vane bearing ring 110 does not have the bevel 200a, 200b. Here, the facing side 111, 151 of the vane bearing ring 110 or of the cover disk 150 that does not have the bevel 200a, 200b may extend (in particular continuously) in the radial direction 24 or run (in particular continuously) perpendicular to the axial direction 22 between the inner circumference and the outer circumferential radius.

FIGS. 2 to 9H show the radial position of the guide vane trailing edge 123 for a plurality of guide vane positions with respect to the bevel(s) 200, 200a, 200b. As described above, the adjustable guide vanes 120 each have a guide vane trailing edge 123. In the case of guide vane positions corresponding to a mass throughput range from a first mass throughput value to a second mass throughput value, at least one portion of the guide vanes 120, in particular the guide vane trailing edge 123, lies in the radial direction 24 in the region of the bevel 200, 200a, 200b. The first mass throughput value is preferably at most 35%. In other words, this means that the bevel 200, 200a, 200b extends in the radial direction 24 in such a way that, from a guide vane position corresponding to a mass throughput value of 35%, based on a maximum mass throughput (in particular of 100%) through the guide device 100, the guide vane trailing edge 123 is located in the radial direction 24 in the region of the bevel 200, 200a, 200b or, from this mass throughput value, moves into this region. In the guide vane positions corresponding to the mass throughput range through the guide device 100, the (in particular complete) guide vane 120 can be located in the radial direction 24 in the flow channel, i.e. in the region in which the cover disk 150 and the vane bearing ring 110 lie opposite one another in the axial direction 22. Consequently, in the case of guide vane positions corresponding to the described mass throughput range from the first mass throughput value to the second mass throughput value, the guide vane trailing edge can lie in the radial direction in the region of the bevel(s) 200, 200a, 200b and in the flow channel, i.e. in the region in which the cover disk 150 and the vane bearing ring 110 lie opposite one another in the axial direction 22. In order to achieve these corresponding guide vane positions, the guide vanes 120 are rotated about a respective axis of rotation PA of the guide vane 120, as a result of which the guide vane trailing edge 123 changes its radial position. The “operation” of the guide device 100 can be described with a standard combustion chamber measurement for guide devices 100, in particular VTGs, in which the measurement range is defined in equally large throughput parameter steps for different guide vane positions in dependence on the mass flow or mass throughput through the guide device 100. As a result of the bevel 200, 200a, 200b in the vane bearing ring 110 and/or the cover disk 150 in the range for certain “open” guide vane positions, an efficiency can be increased by the guide device 100, in particular for a certain range of “open” guide vane positions. The fact that the trailing edge 123 of the adjustable guide vanes 120 is located in the radial direction 24 in the region of the bevel 200, 200a, 200b in the case of guide vane positions corresponding to the mass throughput range necessitates a certain radial arrangement and extent of the bevel 200, 200a, 200b, and of the cover disk 150 and/or of the vane bearing ring 110 (or the flow channel formed by these components), with respect to the guide vanes 120 and thus the corresponding guide vane positions.

Furthermore, a continuous flow profile can be provided by the guide device 100 according to the invention and an improved incident flow to the turbine wheel 20 can be achieved. In addition, sudden widening or changes of a flow channel width X_{S} can be prevented. Enthalpy losses can be compensated for when the guide device 100 is used in a turbine 10. When used with an internal combustion engine, better fuel consumption can be achieved. Furthermore, the bevel 200, 200a, 200b makes it possible to reduce or prevent jamming of the guide vanes 120 in the case of high temperature use (and corresponding thermal expansions of the components).

In preferred refinements, the first mass throughput value may be at most or exactly 30%, in particular at most or exactly 20%, more specifically at most or exactly 10%. In preferred refinements that can be combined in any desired manner with the described first mass throughput values, the second mass throughput value may be at least or exactly 55%, more specifically at least or exactly 65%, in particular at least or exactly 70%. The described first and second mass throughput values result in the corresponding mass throughput ranges which are linked to respective guide vane positions and for which at least one portion of the guide vane 120, in particular the guide vane trailing edge 123, lies in the radial direction 24 in the region of the bevel 200, 200a, 200b. A greater mass throughput range consequently necessitates a greater radial arrangement and extent of the bevel(s) 200, 200a, 200b, and of the cover disk 150 and/or of the vane bearing ring 110, with respect to the guide vanes 120 or guide vane positions. In the case of guide vane positions corresponding to the preferred mass throughput ranges that follow, the guide vane trailing edge 123 may lie in the radial direction 24 in the region of the bevel(s) 200, 200a, 200b (and in particular in the region of the bevel(s) and in the flow channel):
the first mass throughput value may be 35% and the second mass throughput value may be 55%, resulting in a mass throughput range from 35% up to 55%;
the first mass throughput value may be 30% and the second mass throughput value may be 65%, resulting in a mass throughput range from 30% up to 65%;
the first mass throughput value may be 20% and the second mass throughput value may be 70%, resulting in a mass throughput range from 20% up to 70%; or
the first mass throughput value may be 10% and the second mass throughput value may be 70%, resulting in a mass throughput range from 10% up to 70%.

However, other mass throughput ranges can also be formed by the aforementioned first and second mass throughput values.

As an alternative to the definition of a respective guide vane position corresponding to a mass throughput range from a first mass throughput value to a second mass throughput value, the respective guide vane position of a guide vane 120 can also be geometrically defined. “Geometrically defined” means that the position of the guide vane 120 is defined not by way of the mass throughput through the guide device but for example by way of an angle of incidence of the guide vane between the first guide vane position and the second guide vane position. For example, an angle of incidence of 50% may mean that the guide vane is open to an extent of 50% between the angle in the first guide vane position and the angle in the second guide vane position. However, it should be noted here that the above-described mass throughput values and ranges based on a maximum mass throughput of 100% through the guide device 100 cannot be equated with an angle of incidence value or range. These differ from one another and generally behave non-linearly.

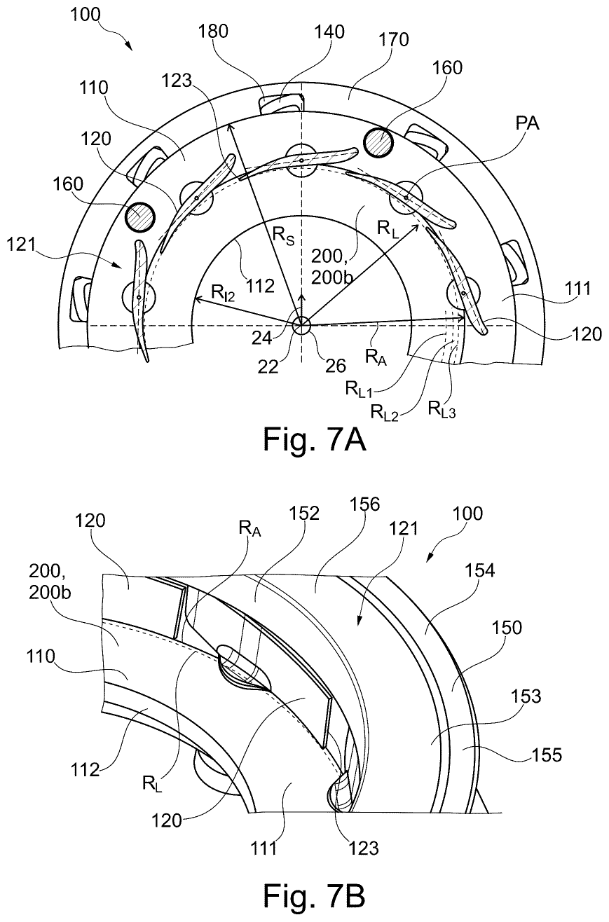

FIGS. 6A to 9H show different guide vane positions of the guide device 100 according to the invention corresponding to the above-described respective mass throughputs or mass throughput ranges. FIGS. 6A and 6B show a sectional view through the guide device 100 of FIGS. 2 to 4B, cut through the guide vanes 120 in the flow channel and in plan view of the cover disk 150. FIGS. 7A and 7B show a sectional view through the guide device 100 of FIGS. 2 to 4B, cut through the guide vanes 120 in the flow channel and in plan view of the vane bearing ring 110. FIGS. 8A to 9H show a plurality of guide vane positions and the respective radial position of the guide vane trailing edge 123 with respect to the bevel(s) 200, 200a, 200b. A trailing edge radius R_{L} can be defined or measured between the axial direction 22 and the guide vane trailing edge 123. The trailing edge radius R_{L} decreases with increasingly opening guide vanes (and thus increasingly “open” guide vane position). In other words, the guide vane trailing edge 123, owing to the rotation about the axis of rotation PA, moves radially inward with increasingly opening guide vanes 120. FIGS. 6A to 9H show different guide vane positions and the corresponding trailing edge radii R_{L}, R_{L1}-R_{L6} (that is to say the corresponding radial position of the trailing edge 123). In the case of guide vane positions corresponding to the mass throughput range, the trailing edge radius R_{L} may be equal to or smaller than the bevel outer radius RA. In the case of guide vane positions corresponding to the mass throughput range, the trailing edge radius R_{L} may be equal to or greater than an inner circumferential radius R_{I1}, R_{I2} of the vane bearing ring 110 and/or of the cover disk 150. In other words, from a guide vane position corresponding to the first mass throughput value, the trailing edge radius R_{L} may be equal to or smaller than the bevel outer radius RA. Consequently, the bevel 200, 200a, 200b extends in the radial direction 24 in such a way that the guide vane trailing edge 123 is located in the radial direction in the region of the bevel 200, 200a, 200b at least from the first mass throughput value. FIGS. 6A, 7A, 7B, and 8A to 8D and 9A to 9D show the respective trailing edge radii R_{L}, R_{L1-6} of the guide vane trailing edge 123 with respect to the bevel(s) for guide vane positions corresponding to the mass throughput values described above. The trailing edge radius R_{L} may in this case be equal to or smaller than the bevel outer radius R_{A} at a first mass throughput value of at most 35% (see R_{L1}), more specifically at most 30% (between R_{L1} and R_{L2}), even more specifically 20% (see R_{L2}), in particular 10% (see R_{L3}). If the first mass throughput value is, for example, 10%, the bevel must extend radially outward as far as this guide vane position. In the case of a smaller guide vane position corresponding to the 10% mass throughput, the trailing edge radius R_{L} may be greater than the bevel outer radius R_{A} (see e.g. R_{L} in FIGS. 8A, 8B, 9A and 9B). In other words, there, the guide vane trailing edge is (as yet) not located in the radial direction 24 in the region of the bevel(s) 200, 200a, 200b. A smaller first mass throughput value necessitates a greater extent of the bevel 200, 200a, 200b radially outward.

In the case of guide vane positions corresponding to the mass throughput range, the trailing edge radius R_{L} may be equal to or greater than the inner circumferential radius R_{I1}, R_{I2} of the vane bearing ring 110 and/or of the cover disk 150. As shown in the figs., the inner circumferential radius R_{I2} of the vane bearing ring 110 may also be smaller than the inner circumferential radius R_{I1} of the cover disk 150. For this case, the cover disk 150 can be arranged with respect to the vane bearing ring 110 in such a way that, in the case of guide vane positions corresponding up to the second mass throughput value, the guide vane trailing edge 123 lies in the radial direction in the region of the bevel 200, 200a, 200b and in the flow channel. In this case, it is only from values higher than the second mass throughput value that the guide vanes 120 may no longer be located completely in the flow channel (i.e. in the region in which the vane bearing ring 110 and the cover disk 150 lie opposite one another in the axial direction 22). For these guide vane positions, at least one portion, in particular of the guide vane trailing edge 123, is arranged radially to the inside of the corresponding greater inner circumferential radius R_{I1}, R_{I2} (in the example shown above inner circumferential radius R_{I1} of the cover disk 150). The second mass throughput value can consequently necessitate a radial extent of the vane bearing ring 110 and/or of the cover disk 150, and of the bevel(s) (in particular an extent of the bevel(s) and of the flow channel radially inward). Performance deficits can be reduced or avoided by the described second mass throughput values. In FIGS. 6B, 8E to 8H and 9E to 9H, the guide vane positions are plotted in accordance with the second mass throughput values described above. In this case, up to the second mass throughput value of at least 55% (see R_{L4}), more specifically at least 65% (between R_{L5}), even more specifically at least 70% (see R_{L6}), the trailing edge radius R_{L} may be equal to or greater than the inner circumferential radius R_{I1}, R_{I2} of the vane bearing ring 110 and/or of the cover disk 150 (or of the flow channel defined by the cover disk and the vane bearing ring). If the second mass throughput value is, for example, 70%, the bevel (and in particular the bevel(s) and the flow channel) must extend radially inward as far as this guide vane position. In the example of FIG. 6B, the guide vane trailing edge 123 and the trailing edge radius (see R_{L7}) are located radially to the inside of the cover disk 150 (or the flow channel) at mass throughput values greater than the mass throughput value of 70%. After the second mass throughput value, the guide vane trailing edge 123 consequently leaves the radial region of the bevel(s) and of the flow channel. Performance deficits can be reduced or avoided by the above-described radial extent of the bevel 200, 200a, 200b, of the vane bearing ring 110 and/or of the cover disk 150 (or of the flow channel formed by these components).

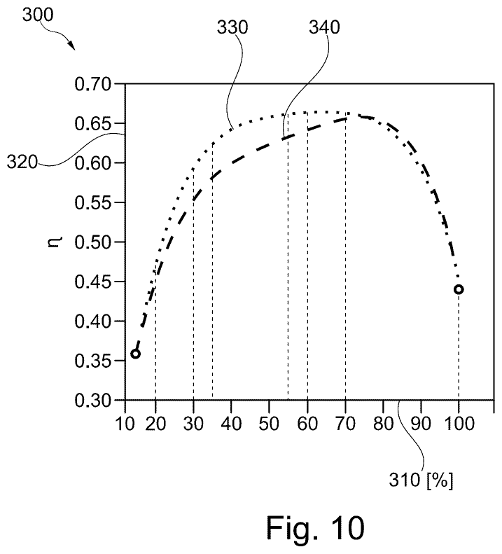

FIG. 10 shows a diagram 300 in which the efficiency 320 is plotted against the mass throughput 310 for different guide vane positions of the guide device 100 according to the invention (see first profile 330), compared with a conventional guide device (see second profile 340). The profiles were determined in each case by tests and simulations for an expansion coefficient during operation (definition see above) of the respective guide devices. In contrast to the guide device 100 according to the invention, the conventional guide device does not have any bevel(s) and additionally also does not have the radial arrangement or extent of the cover disk 150 and/or of the vane bearing ring 110 (or of the flow channel) with respect to the guide vanes 120. In diagram 300, the efficiency 320 (or η), which is linked to the efficiency of the guide device during operation, is plotted on the ordinate axis. The mass throughput 310 in percent is indicated on the abscissa axis. The profiles 330, 340 represent different guide vane positions of the guide device 100 according to the invention and of the conventional guide device. The profiles 330, 340 each have second guide vane positions which correspond to a maximum mass throughput of 100%. The profiles each have first guide vane positions which correspond to a minimum mass throughput greater than 0% mass throughput. A comparison of the profiles 330, 340 reveals that the features of the guide device 100 according to the invention can increase the efficiency, in particular for guide vane positions corresponding to at least 20% to 60% mass throughput, in particular 10% to 70% mass throughput. Consequently, the efficiency of the guide device 100 according to the invention can also be increased in this range. This also applies to the guide vane positions of the guide device 100 according to the invention corresponding to the described mass throughput ranges.

As already mentioned above, the vane bearing ring 110 and the cover disk 150 can define a flow channel in which the adjustable guide vanes 120 are arranged. The flow channel can have a flow channel width X_{S} which is measured in the axial direction 22 between the vane bearing ring 110 and the cover disk 150 (see FIG. 3B and FIG. 3C). The flow channel width X_{S} may be substantially constant, in particular constant, in the radial region between an outer circumference R_{D}, R_{S} of the vane bearing ring 110 and/or of the cover disk 150 and the bevel outer radius R_{A} (this region can be referred to as constant region). The flow channel width X_{S} may increase between the bevel outer radius R_{A} and the inner circumference 112, 152 of the vane bearing ring 110 and/or of the cover disk 150 (this region can be referred to as bevel region). In particular, the flow channel width X_{S} may increase constantly in the bevel region. The axial width X_{V} of the guide vane(s) 120 is smaller than the flow channel width X_{S}. In refinements, the flow channel width X_{S} may increase constantly from the bevel outer radius R_{A} up to the inner circumference 112, 152, that is to say in the widening region. In refinements, the bevel region may have at least a second constant region. In one refinement, as seen from the inner circumference 112, 152 in the radial direction 24 up to the bevel outer radius R_{A}, the flow channel may have a second constant region, followed by the bevel 200, 200a, 200b. In other words, the flow channel can taper from the second constant region through the bevel toward the (first) constant region. In refinements, the bevel 200, 200a, 200b may have in the radial direction 22 at least two bevels with different gradient. If the bevel 200a, 200b is provided in the vane bearing ring 110 and in the cover disk 150, the bevel may in each case be configured symmetrically with respect to the guide vanes 120, or may be configured differently. If the vane bearing ring 110 has a smaller inner circumferential radius R_{I2} than the cover disk 150 (see R_{I1}), then the bevel 200b (or the widening region) of the vane bearing ring 110 can also extend further radially inward than the bevel 200a of the cover disk 150. In refinements (not shown in the figs.) in which the cover disk and the vane bearing ring each have the bevel, both bevels have the same bevel outer radius R_{A}. In other refinements, the bevel 200a of the cover disk 150 may also extend up to a first bevel outer radius and the bevel 200b of the vane bearing ring 110 may extend up to a second bevel outer radius. The first bevel outer radius may be greater or smaller than the second bevel outer radius.

As described above and illustrated in FIGS. 6A to 9H, the adjustable guide vanes 120 may each have a guide vane axis of rotation PA, the bevel outer radius R_{A} being smaller than an axis of rotation radius R_{PA}, which is measured radially between the axial direction 22 and the guide vane axis of rotation PA. In particular, the bevel outer radius R_{A} may be at most 15%, in particular at most 10%, smaller than the axis of rotation radius R_{PA}. In FIGS. 6A to 8E, the guide vanes 120 have a first axial position X_{PA1} of the guide vane axis of rotation PA, in particular which lies in the range of 0.40≤X_{PA1}/C≤0.50. In FIGS. 9A to 9H, the guide vanes 120 have a second axial position X_{PA2} of the guide vane axis of rotation PA, which is offset in relation to the first axial position toward the guide vane leading edge and in particular which lies in the range of 0.20≤X_{PA2}/C≤0.35. Here, the respective axial position X_{PA1}, X_{PA2} can be measured parallel to a profile chord C of the guide vane 120 between the guide vane leading edge and the pivot point PA. The profile chord C is a straight line which centrally intersects the guide vane leading edge and trailing edge and is known for the description of a profile geometry. The above-described guide vane positions corresponding to the mass throughput ranges and the associated radial positions of the guide vane trailing edge with respect to the bevel(s) (or the flow channel) can also be applied analogously for this configuration (offset of the axis of rotation with respect to the leading edge). Only the radial position of the axis of rotation R_{PA} with respect to the vane bearing ring 110 (that is to say the mounting of the guide vanes in the vane bearing ring) is adapted, the radial position of the axis of rotation R_{PA} being measured between the axial direction 22 and the pivot point PA. For the first axial position X_{PA1}, the axis of rotation PA of the guide vane 120 has a first radial position R_{PA1}. For the second axial position X_{PA2}, the axis of rotation PA of the guide vane 120 has a second radial position R_{PA2}. The second radial position R_{PA2} is greater than the first radial position R_{PA1}. In other words, the movement sequence of the guide vane trailing edge 123 in the case of a changed axial position of the axis of rotation PA can be compensated for by an offset of the radial position of the axis of rotation, such that the principles described herein are applicable to various arrangements of the guide vane axis of rotation PA. In the refinements described above, each guide vane has the same axial and radial position of the axis of rotation.

In refinements, the guide device 100, in particular the cover disk 150 and/or the vane bearing ring 110, may have an outer radius R_{D}, R_{S}, a ratio of the bevel outer radius R_{A} to the outer radius R_{D}, R_{S} being from 0.60 to 0.85, in particular from 0.65 to 0.80. In refinements, the inner circumferential radius R_{I2} of the vane bearing ring 110 may be smaller than, equal to or greater than the inner circumferential radius Rn of the cover disk 150.

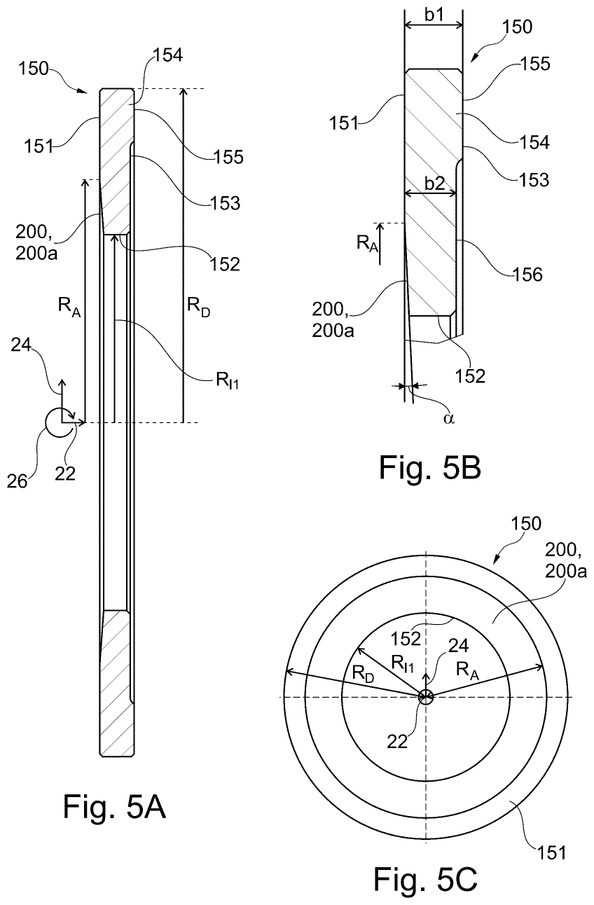

With reference to FIGS. 2 to 3C and 5A to 5C, the cover disk 150 is described in more detail below. The cover disk 150 may have an axial, disk-shaped extent 154 on a side 153 facing away from the adjustable guide vanes 120. This may be arranged in a radially outer region of the cover disk 150. The cover disk 150 consequently has a depression 156, in particular which extends in the radial direction 24 between the inner circumference 152 and the axial extent 154, on the facing-away side 153 in a radially inner region. As shown in FIG. 5B, the cover disk 150 can consequently have a first axial width b1 in the region of the extent 154, and a second, smaller axial width b2 in the region of the depression 156. In particular, the axial extent 154 has an axial surface 155 which serves as an axial bearing surface and for the introduction of forces during the mounting of the guide device 100 in a turbine housing 30 in the axial direction 22. In particular, the disk-shaped extent 154 may be arranged in the radial direction 24 in the region of the spacer elements 160. As a result of this arrangement, the forces transmitted to the cover disk 150 by the spacer elements 160 can be introduced directly axially into the turbine housing 30 by way of the extent 154. This makes it possible to improve a surface pressure. More specifically, a radial width of the extent may be greater than a radial width of the spacer elements 160.

As illustrated in FIGS. 3C and 5B for the cover disk 150 (the same applies to the vane bearing ring 110), the bevel 200, 200a, 200b between the inner circumference 112, 152 of the vane bearing ring 110 and/or of the cover disk 150 may run in a planar manner and/or curved manner (in particular convexly with respect to the guide vanes) in the radial direction 24 as far as the bevel outer radius R_{A}. A bevel angle α, β can be measured between the facing side 111, 151 and the bevel 200, 200a, 200b. In refinements, a bevel angle α, β may be from 0.5° to 5.0°. In this refinement, the bevel (in cross section) can run linearly. In refinements, the vane bearing ring 110 and the cover disk 150 may have the bevel 200a, 200b. A first bevel angle α of the bevel 110 of the cover disk 150 may be greater than a second bevel angle β of the bevel 200a of the vane bearing ring 110. In refinements, the bevel angle α may be from 1° to 4°, in particular from 2° to 3°. In the refinements in which the vane bearing ring 110 and the cover disk 150 have the bevel 200a, 200b (see FIG. 3C), the bevel 200a of the cover disk 150 may have a first gradient and the bevel 200b of the vane bearing ring 110 may have a second gradient. The first gradient may be greater than the second gradient, in particular the ratio of the first gradient to the second gradient at radial positions (that is to say in the radial region of the bevels 200a, 200b) for guide vane positions corresponding to the mass throughput range being from 2.00 to 5.00, more specifically from 3.00 to 4.00, in particular from 3.25 to 3.75. In refinements in which the vane bearing ring 110 and the cover disk 150 have the bevel 200a, 200b, it is possible in the radial direction 24 in the region of the bevels 200a, 200b, at each radial position, for a first axial distance S1 between the guide vane 120 and the cover disk 150 to be greater than a second axial distance S2 between the guide vane 120 and the vane bearing ring 110 (see FIG. 3C).

As shown in FIGS. 5C and 7A, the bevel 200, 200a, 200b extends completely circumferentially on the facing side 111, 151. In other refinements, the bevel 200, 200a, 200b may extend only partially circumferentially. In refinements, the bevel 200, 200a, 200b may have at least two bevel portions, which each extend over a circumferential portion (for example circumferential region in which respective guide vanes or the trailing edge thereof are provided). The respective circumferential portions may be the same size. Webs which separate the circumferential portions from one another may be arranged between the respective circumferential portions. The bevel 200, 200a, 200b may thus also be provided only in the region of certain guide vanes 120. If the bevel 200, 200a, 200b extends only partially circumferentially, only certain guide vane trailing edge(s) of the guide vane(s) which are correspondingly positioned may be located in the region of the bevel 200, 200a, 200b for the described mass throughput ranges. For example, the bevel 200, 200a, 200b may have the (above-described) at least two bevel portions, which each extend over a certain circumferential portion. The guide vanes can be arranged with respect to the bevel portions in such a way that at least one guide vane trailing edge is located in the region of a respective bevel portion for the described mass throughput ranges.

As illustrated in FIGS. 2 to 3B, the turbine housing 30 has a shoulder 31 for axially and radially mounting the cover disk 150. The shoulder 31 may have a ring-shaped, axial projection 31a which extends toward the bearing housing 40, is arranged radially to the inside of the cover disk 150 and forms a radial surface pairing with an inner circumference 152 of the cover disk 150. The shoulder 31, in particular the projection 31a, has an end side 31c (see FIG. 3B). If the cover disk 150 has the bevel 200a, the bevel 200a may be flush with the end side 31c of the shoulder 31 in the axial direction 22 at the inner circumference 152 of the cover disk 150. As a result, a moderate transition between the guide device 100, in particular the cover disk 150, and the turbine housing 30 may be provided on a side facing the guide vanes 120. In addition, a more uniform inflow from the flow channel to the turbine wheel 20 may be provided. The shoulder 31 may have an axial surface 31b. The axial surface 31b of the shoulder 31 and the axial, disk-shaped extent 154 of the cover disk 150 may form an axial surface pairing, on the basis of which the above-described axial forces can be introduced from the guide device 100 into the turbine housing 30.

The turbine wheel 20 has a turbine wheel rear wall 21 and a hub wall 21b opposite the turbine wheel rear wall 21. The turbine wheel 20 has a plurality of turbine wheel vanes, which each have an incident-flow edge 21c (see FIG. 3B). In preferred refinements, the facing side of the vane bearing ring 110 (in the case that the vane bearing ring 110 does or does not comprise the bevel) at the inner circumference 112 in the axial direction 22 may be flush with the hub wall 21b at a turbine wheel radius R_{T} (measured radially between the axial direction 22 and the outer circumference of the turbine wheel 20). The axial width of the flow channel X_{S}, measured at the inner circumference 152 of the cover disk 150, can be wider than an axial width of the incident-flow edge 21c. In refinements, a first axial distance between the vane bearing ring 110 and the cover disk 150 and/or the end side 31c of the shoulder 31, measured at the inner circumference 152 of the cover disk 150 in the axial direction 22, may be equal to or greater than a second axial distance between the vane bearing ring 110 and a point of the incident-flow edge 21c farthest away from the vane bearing ring. By means of the features described above, an improved and more uniform incident flow to the turbine wheel 20 from the flow channel of the guide device 100 can be provided.

As can be seen from FIG. 3B, if the cover disk 150 has the bevel 200a, the inner circumferential radius R_{I1} of the cover disk 150 may be equal to or greater than the turbine wheel radius R_{T}. In particular, a ratio of the turbine wheel radius R_{T} to the inner circumferential radius R_{I1} may be from 0.75 to 1.00, in particular from 0.80 to 0.98, more specifically from 0.85 to 0.95. On the basis of this refinement, a greater radial extent of the flow channel can be provided and an improved inflow to the turbine wheel can be provided. In refinements, the ratio may also be greater than 1.00. In this case, the shoulder 31 of the turbine housing 30 may also be offset radially inward, or not be provided (for example, the radial mounting of the cover disk can then be replaced by suitable connecting means such as form-fitting or force-fitting connections).

As also shown in FIGS. 2A to 4B, 7A and 7B, the guide device 100 comprises an adjusting ring 170. The plurality of adjustable guide vanes 120 are adjustable by means of a movement of the adjusting ring 170 in the circumferential direction 26 between the first guide vane position and the second guide vane position. In particular, the adjusting device 60 is operatively coupled to the adjusting ring 170 and designed to move the adjusting ring 170 in the circumferential direction 26. The actuating device 60 is coupled to the adjusting ring 170 via one or more levers and/or a control rod. Each guide vane 120 comprises a vane shaft 130, which is coupled to the guide vane body for conjoint rotation, in particular the vane shaft 130 being formed in such a way that the guide vane 120 can be mounted rotatably via the vane shaft 130 in the vane bearing ring 110 of the guide device 100. A longitudinal axis or axis of rotation of the vane shaft 130 defines the guide vane axis of rotation PA. In other words, the plurality of guide vanes 120 are each rotatably mounted in the vane bearing ring 110 via a vane shaft 130. The guide vanes 120 are rotationally mounted in the vane bearing ring 110 and can be rotated or adjusted via the adjusting ring 170. In particular, the adjustable guide vanes 120 can be mounted rotatably in the vane bearing ring 110 by means of the vane shafts 130 in a manner distributed uniformly in the circumferential direction 26. Here, the vane shafts 130 extend in the axial direction 22, in particular parallel to the axis of rotation R. Alternatively, the guide vanes 120 are rotationally mounted along a respective guide vane axis of rotation PA in the vane bearing ring 110, the respective guide vane axis of rotation PA running parallel to the axial direction 22 or axis of rotation R. An odd number of guide vanes 120 can be provided. More than eight guide vanes, in particular more than ten guide vanes (e.g. 11 guide vanes), preferably more than 12 guide vanes can be provided. Exactly 13 guide vanes 120 can be provided. In other refinements, an even number of guide vanes 120 can be provided.

Each guide vane 120 of the plurality of adjustable guide vanes 120 is connected to one vane lever 140 each for conjoint rotation. Each vane lever 140 is at least partially accommodated in each case in a coupling region 180 of the adjusting ring 170 for adjusting the respective guide vane 120. In other words, the vane levers 140 are operatively coupled to the adjusting ring 170 (see FIGS. 4A, 7A). When the adjusting ring 170 rotates in the circumferential direction 26, the guide vanes 120 can be adjusted. As described above, the guide vane bodies are each connected to the respective vane shaft 130 at a first end of the vane shaft 130 for conjoint rotation. The vane lever 140 is connected to the vane shaft 130 at a second end of the vane shaft 130 opposite the first end. Each vane lever 140 can have a radial vane lever portion 141 which extends radially from the vane shaft 130. In addition, each vane lever 140 can have an axial vane lever portion 142, which extends axially from the radial vane lever portion 141 to the adjusting ring 170. In particular, the axial vane lever portion 142 can extend axially at least partially into the respective coupling region 180. The axial vane lever portion 142 can extend from the radial vane lever portion 141 predominantly parallel to the vane shaft 130. As shown in the figs., the vane levers 140 and the guide vanes 120 can be arranged on opposite sides of the vane bearing ring 110.

As indicated in FIGS. 2 and 3B, the guide device 100 can further comprise an inlet guide grate 190 which circumferentially surrounds the vane bearing ring 110 and/or the plurality of adjustable guide vanes 120. The inlet guide grate 190 can have a plurality of fixed inlet guide vanes. The fixed inlet guide vanes can be arranged in each case between two adjacent, adjustable guide vanes 120, in particular within an outer circumference of the guide device 100. The fixed inlet guide vanes are provided with a fixed angle of incidence. In other words, the inlet guide vanes are not rotatable or adjustable. In refinements, the inlet guide grate 190 can also replace the spacer elements 160 and ensure the axial distance or the flow channel width X_{S} between the vane bearing ring 110 and the cover disk 150.

As already described above, the guide device 100 has an adjusting ring 170, which comprises a disk-shaped body (or ring-shaped body) and the plurality of coupling regions 180 are formed in the disk-shaped body. The coupling regions 180 are spaced apart in the circumferential direction 26. The respective vane levers 140 are in engagement with one coupling region 180 each, and therefore, in a movement of the adjusting ring 170 in the circumferential direction 26, this movement can be transmitted to the vane levers 140 and thus to the adjustable guide vanes 120. In particular, rotation of the adjusting ring 170 in the circumferential direction 26 leads to rotation of the respective guide vanes 120 about their respective guide vane axis of rotation PA, and in particular to an adjustment of the respective guide vanes 120. In the refinements shown, “partially accommodated” means that the respective vane lever 140 extends in the respective coupling region 180, in particular in the axial direction 22, in such a way that a transmission of force between the adjusting ring 170 and the vane levers 140 can take place during a movement of the adjusting ring 170 in the circumferential direction 26.

As shown for example in FIGS. 2, 3A and 3B, the turbine 10 can comprise a clamping means 500 which is arranged in the axial direction 22 between the guide device 100, in particular the vane bearing ring 110, and the turbine rear wall 32. The clamping means 500 can be designed to clamp the guide device 100 against the turbine housing 30 in such a way that an axial force is introduced via the axial, disk-shaped extent 154 into the turbine housing 30 in the axial direction 22. The clamping means 500 can be designed as a disk spring. The clamping means 500 has a radially outer end and a radially inner end. The clamping means 500 can abut at its radially outer end against the vane bearing ring 110 and at its radially inner end against the turbine rear wall 32. In addition, the turbine 10 can comprise a heat shield 600. Heat transfer from the turbine 10 to the bearing housing 40 and/or to the compressor 50 can be reduced by the heat shield 600. The heat shield 600 can be arranged in the axial direction 22 between the turbine wheel 20 and the bearing housing 40, in particular between the guide device 100 and the bearing housing 40. More specifically, the heat shield 600 can be clamped between the clamping means 500 and the vane bearing ring 110. In particular, the heat shield 600 can be clamped between the vane bearing ring 110 and the radially outer end of the clamping means 500. The clamping means 500 can lie in an indirectly contacting manner against the vane bearing ring 110 via the heat shield 600. The clamping means 500 can form a linear contact with the bearing housing 40 and form a surface contact with the heat shield 600, in particular at its radially outer end. In alternative refinements, the clamping means 500 can, however, also lie in a directly contacting manner against the vane bearing ring 110. Based on the spacer elements 160 and/or the inlet guide grate 190, the preloading force generated by the clamping means 500 can be transmitted axially from the vane bearing ring 110 to the cover disk 150 and to the turbine housing 30.

In the refinements described above, reference is often made to only one bevel 200. The refinements described above apply to the bevel 200, 200a of the cover disk 150, the bevel 200, 200b of the vane bearing ring, and/or in each case to the bevels 200a, 200b of the vane bearing ring 110 and of the cover disk 150. As described above, the guide device 100 comprises a plurality of adjustable guide vanes 120. In specific refinements, the guide device 100 can also have at least one fixed guide vane (that is to say a guide vane which is connected to the vane bearing ring 110 for conjoint rotation). Although the guide vanes 200 are oriented counterclockwise in FIGS. 2 to 4B, 6A and 6B (that is, the respective leading edges of the vanes are oriented counterclockwise), as seen in the axial direction 22 in the direction of the cover disk 150, they can also be oriented clockwise (that is, the respective leading edges of the vanes are oriented clockwise), such as the guide vanes 120 are illustrated for example in FIGS. 7A to 9H. Of course, all the guide vanes 120 have the same orientation in a guide device 100 according to the invention. Although the guide device 100 is substantially ring-shaped and the guide vanes 200 are illustrated spaced apart from one other in the circumferential direction 26, the guide device 100 can also be provided in other refinements in such a way that the adjustable guide vanes are arranged linearly next to one other and spaced apart from one other. Of course, the other components of the guide device 100 are adapted accordingly in such a refinement.

Although the present invention has been described above and defined in the appended claims, it should be understood that the invention may alternatively also be defined in accordance with the following embodiments:
1. A guide device (100) for a turbine (10), comprising:
   a vane bearing ring (110),
   a cover disk (150) which is arranged parallel to the vane bearing ring (110) and spaced apart therefrom in the axial direction (22) by spacer elements (160), and
   a plurality of adjustable guide vanes (120) which are each mounted rotatably and adjustably in the vane bearing ring (110), the adjustable guide vanes (120) being arranged between the cover disk (150) and the vane bearing ring (110),
   the adjustable guide vanes (120) being adjustable between a first guide vane position,
   in which the guide vanes are minimally open, and a second guide vane position (122),
   in which the guide vanes are maximally open,
   the respective guide vane position during operation of the guide device (100) being linked to a corresponding mass throughput through the guide device (100), in particular the mass throughput being 100% in the second guide vane position,
   the vane bearing ring (110) and/or the cover disk (150) having a bevel (200, 200a, 200b) which, on a side (111, 151) of the vane bearing ring (110) and/or of the cover disk (150) facing the adjustable guide vanes, extends from an inner circumference (112, 152) of the vane bearing ring (110) and/or of the cover disk (152) in the radial direction (24) to a bevel outer radius (R_{A}),
   the adjustable guide vanes (120) each having a guide vane trailing edge (123), the guide vane trailing edge (123) lying in the radial direction (24) in the region of the bevel (200, 200a, 200b) in the case of guide vane positions corresponding to a mass throughput range from a first mass throughput value to a second mass throughput value,
   the first mass throughput value being at most 35%.
2. The guide device (100) according to embodiment 1, the first mass throughput value being at most 30%, in particular at most 20%, more specifically 10%.
3. The guide device (100) according to embodiment 1 or embodiment 2, the second mass throughput value being at least 55%, more specifically at least 65%, in particular 70%.
4. The guide device (100) according to any one of the preceding embodiments, the first mass throughput value being 35% and the second mass throughput value being 55%, or
   the first mass throughput value being 30% and the second mass throughput value being 65%, or
   the first mass throughput value being 20% and the second mass throughput value being 70%, or
   the first mass throughput value being 10% and the second mass throughput value being 70%.
5. The guide device (100) according to any one of the preceding embodiments, a trailing edge radius (R_{L}) being defined between the axial direction (22) and the guide vane trailing edge (123), the trailing edge radius (R_{L}) decreasing with increasingly opening guide vanes, and the guide vane trailing edge (123) lying in the radial direction (24) in a flow channel, in which the cover disk (150) and the vane bearing ring (110) lie opposite one another in the axial direction (22), in the case of guide vane positions corresponding to the mass throughput range from the first mass throughput value to the second mass throughput value.
6. The guide device (100) according to embodiment 5, the trailing edge radius (R_{L}) being equal to or smaller than the bevel outer radius (R_{A}) in the case of guide vane positions corresponding to the mass throughput range.
7. The guide device (100) according to embodiment 5 or 6, the trailing edge radius (R_{L}) being equal to or greater than an inner circumferential radius (R_{I1}, R_{I2}) of the vane bearing ring (110) and/or of the cover disk (150) in the case of guide vane positions corresponding to the mass throughput range.
8. The guide device (100) according to any one of the preceding embodiments, the vane bearing ring (110) and the cover disk (150) defining a flow channel in which the adjustable guide vanes (120) are arranged,
   the flow channel having a flow channel width (X_{S}) which is measured in the axial direction (22) between the vane bearing ring (110) and the cover disk (150),
   the flow channel width (X_{S}) being constant between an outer circumference of the vane bearing ring (110) and/or of the cover disk (150) and the bevel outer radius (R_{A}), and
   the flow channel width (X_{S}) increasing between the bevel outer radius (R_{A}) and the inner circumference (112, 152) of the vane bearing ring (110) and/or the cover disk (150).
9. The guide device (100) according to any one of the preceding embodiments, the adjustable guide vanes (120) each having a guide vane axis of rotation (PA), the bevel outer radius (R_{A}) being smaller than an axis of rotation radius (R_{PA}) which is measured between the axial direction (22) and the guide vane axis of rotation (PA), in particular the bevel radius (R_{A}) being at most 10% smaller than the axis of rotation radius (R_{PA}).
10. The guide device (100) according to any one of the preceding embodiments, the guide vanes (120) being mounted at a uniform spacing in the circumferential direction (26) in the vane bearing ring (110), and adjacent guide vanes (120) being distanced from one another in the first guide vane position.
11. The guide device (100) according to any one of the preceding embodiments, the cover disk (150) comprising the bevel (200, 200a), in particular the facing side (111) of the vane bearing ring (110) running perpendicularly with respect to the axial direction (22).
12. The guide device (100) according to any one of the preceding embodiments, an inner circumferential radius (R_{I2}) of the vane bearing ring (110) being smaller than an inner circumferential radius (R_{I1}) of the cover disk (150).
13. The guide device (100) according to any one of the preceding embodiments, the cover disk (150) having the bevel (200a) and the cover disk (150) having an outer radius (RD), a ratio of the bevel outer radius (R_{A}) to the outer radius (R_{D}) being from 0.60 to 0.85, in particular from 0.65 to 0.80.
14. The guide device (100) according to any one of the preceding embodiments, the cover disk (150) having, on a side (153) facing away from the adjustable guide vanes (120), an axial, disk-shaped extent (154) which is arranged in a radially outer region of the cover disk (150).
15. The guide device (100) according to embodiment 14, the disk-shaped extent (154) being arranged in the radial direction (24) in the region of the spacer elements (160).
16. The guide device (100) according to any one of the preceding embodiments, the bevel (200, 200a, 200b) between the inner circumference (112, 152) of the vane bearing ring (110) and/or the cover disk (150) running in a planar manner and/or curved manner in the radial direction (24) as far as the bevel outer radius (R_{A}).
17. The guide device (100) according to any one of the preceding embodiments, a bevel angle (α, β) being measured between the facing side (111, 151) and the bevel (200, 200a, 200b), the bevel angle (α) being from 0.5° to 5.0°.
18. The guide device (100) according to embodiment 17, the vane bearing ring (110) and the cover disk (150) having the bevel (200a, 200b), a first bevel angle (α) of the bevel (200a) of the cover disk (150) being greater than a second bevel angle (β) of the bevel (200b) of the vane bearing ring (110).
19. The guide device (100) according to embodiment 17 or 18, the cover disk (150) having the bevel (200a), the bevel angle (α) of the bevel (200a) being from 1° to 4°, in particular from 2° to 3°.
20. The guide device (100) according to any one of the preceding embodiments, the vane bearing ring (110) and the cover disk (150) having the bevel (200a, 200b), the bevel (200a) of the cover disk (150) having a first gradient and the bevel (200b) of the vane bearing ring (110) having a second gradient, the first gradient being greater than the second gradient, in particular the ratio of the first gradient to the second gradient at radial positions for guide vane positions corresponding to the mass throughput range being from 2.00 to 5.00, more specifically from 3.00 to 4.00, in particular from 3.25 to 3.75.
21. The guide device (100) according to any one of the preceding embodiments, the vane bearing ring (110) and the cover disk (150) having the bevel (200a, 200b), in the radial direction (24) in the region of the bevels (200a, 200b), at each radial position, a first axial distance (S1) between the guide vane (120) and the cover disk (150) being greater than a second axial distance (S2) between the guide vane (120) and the vane bearing ring (110).
22. The guide device (100) according to any one of the preceding embodiments, the bevel (200, 200a, 200b) extending completely circumferentially on the facing side (111, 151).
23. The guide device (100) according to any one of the preceding embodiments, the guide device (100) being a variable turbine geometry.
24. The guide device (100) according to any one of the preceding embodiments, the guide device (100) comprising an adjusting ring (170), the adjusting ring (170) comprising a plurality of coupling regions (180), and each adjustable guide vane (120) of the plurality of adjustable guide vanes (120) being connected to one vane lever (140) each for conjoint rotation, in particular each vane lever (140) being at least partially accommodated in a respective coupling region (180) for adjusting the respective adjustable guide vane (120).
25. The guide device (100) according to embodiment 24, the adjustable guide vane (120) being connected to a vane shaft (130) at a first end of the vane shaft (130) for conjoint rotation, and the vane lever (140) being connected to the vane shaft (130) at a second end of the vane shaft (130) opposite the first end.
26. The guide device (100) according to embodiment 24 or embodiment 25, each vane lever (140) having a radial vane lever portion (141) which extends radially from the vane shaft (130), and an axial vane lever portion (142) which extends axially from the radial vane lever portion (141) to the adjusting ring (170), in particular the axial vane lever portion (142) extending axially at least partially into the respective coupling region (180).
27. The guide device (100) according to any one of embodiments 24 to 26, the adjustable guide vanes (120) being mounted rotatably in the vane bearing ring (110) by means of the vane shafts (130) in a manner distributed uniformly in the circumferential direction (26).
28. The guide device (100) according to any one of the preceding embodiments, the guide device (100) having an odd number of adjustable guide vanes (120).
29. The guide device (100) according to any one of the preceding embodiments, at least three spacer elements (160) being provided, which are each connected to at least the vane bearing ring (110) at a uniform spacing in the circumferential direction (26).
30. The guide device (100) according to any one of the preceding embodiments, the spacer elements (160) being arranged in the radial direction (24) between the bevel outer radius (R_{A}) and an outer radius (R_{D}, R_{S}) of the cover disk (150) and of the vane bearing ring (110), in particular the respective spacer elements (160) being fixedly connected to the cover disk (150) and/or the vane bearing ring (110).
31. The guide device (100) according to any one of the preceding embodiments 24 to 30, comprising an actuating device (60) which is operatively coupled to the adjusting ring (170) and designed to move the adjusting ring (170) in the circumferential direction (26), in particular the actuating device (60) being coupled to the adjusting ring (170) via one or more levers and/or a control rod.
32. A turbine (10) for a supercharging apparatus (1), comprising:
   a turbine housing (30),
   a turbine wheel (20) which is arranged rotatably in the turbine housing (30), and
   a guide device (100) according to any one of the preceding embodiments which is arranged radially outside the turbine wheel (20) in the turbine housing (30) and circumferentially surrounds the turbine wheel (20).
33. The turbine (10) according to embodiment 32, the turbine housing (30) having a shoulder (31) for axially and radially mounting the cover disk (150), in particular the shoulder (31) having a ring-shaped, axial projection (31a) which is arranged radially to the inside of the cover disk (150) and forms a radial surface pairing with an inner circumference (152) of the cover disk (150).
34. The turbine (10) according to embodiment 33, the shoulder (31), in particular the projection (31a), having an end side (31c), and the cover disk (150) having the bevel (200, 200a), the bevel (200, 200a) being flush with the end side (31c) of the shoulder (31) in the axial direction (22) at the inner circumference (152) of the cover disk (150).
35. The turbine (10) according to embodiment 33 or embodiment 34, the shoulder (31) having an axial surface (31b) and the cover disk (150) having an axial, disk-shaped extent (154) which is arranged in a radially outer region of the cover disk (150), the axial surface (31b) of the shoulder and the axial, disk-shaped extent (154) forming an axial surface pairing.
36. The turbine (10) according to any one of embodiments 32 to 35, the cover disk (150) having the bevel (200, 200a) and an inner circumferential radius (R_{I1}), the inner circumferential radius (R_{I1}) being equal to or greater than a turbine wheel radius (R_{T}), in particular a ratio of a turbine wheel radius (R_{T}) to the inner circumferential radius (R_{I1}) being from 0.75 to 1.00, in particular from 0.80 to 0.98, more specifically from 0.85 to 0.95.
37. The turbine (10) according to any one of embodiments 32 to 36, comprising a clamping means (500), the clamping means (500) being arranged in the axial direction (22) between the guide device (100) and a turbine rear wall (32), in particular the clamping means (500) being designed to clamp the guide device (100) against the turbine housing (30) in such a way that an axial force is introduced via the axial, disk-shaped extent (154) into the turbine housing (30).
38. The turbine (10) according to embodiment 37, wherein the clamping means (500) abuts at its radially outer end against the vane bearing ring (110) and at its radially inner end against the turbine rear wall (32).
39. The turbine (10) according to embodiment 37 or embodiment 38, wherein a heat shield (600) is clamped between the clamping means (500) and the vane bearing ring (110). The turbine (10) according to any one of embodiments 37 to 39, wherein the turbine rear wall (32) is formed as part of a bearing housing (40).
40. A supercharging apparatus (1) for an internal combustion engine or a fuel cell, comprising:
   a bearing housing (40),
   a shaft (70) which is mounted rotatably in the bearing housing (40),
   a compressor (50) with a compressor wheel (52), and
   a turbine (10) according to any one of embodiments 32 to 40, the turbine wheel (20) and the compressor wheel (52) being coupled to the shaft (70) at opposite ends of the shaft (70) for conjoint rotation.
42. The supercharging apparatus (1) according to embodiment 42, the compressor (50) comprising a compressor housing (51) in which the compressor wheel (52) is arranged, the bearing housing (40) being connected to the turbine housing (30) and to the compressor housing (51).
43. The supercharging apparatus (1) according to embodiment 41 or embodiment 42, comprising an electric motor which is arranged in an engine compartment in the bearing housing (40), the turbine wheel (20) and/or the compressor wheel (52) being coupled to the electric motor via the shaft (70).

1. A guide device (100) for a turbine (10), comprising:
a vane bearing ring (110),
a cover disk (150) which is arranged parallel to the vane bearing ring (110) and spaced apart therefrom in the axial direction (22) by spacer elements (160), and
a plurality of adjustable guide vanes (120) which are each mounted rotatably and adjustably in the vane bearing ring (110), the adjustable guide vanes (120) being arranged between the cover disk (150) and the vane bearing ring (110),
the adjustable guide vanes (120) being adjustable between a first guide vane position, in which the guide vanes are minimally open, and a second guide vane position (122), in which the guide vanes are maximally open,
the respective guide vane position during operation of the guide device (100) being linked to a corresponding mass throughput through the guide device (100), the mass throughput being 100% in the second guide vane position,
at least one of the vane bearing ring (110) and the cover disk (150) having a bevel (200, 200a, 200b) which, on a side (111, 151) of at least one of the vane bearing ring (110) and of the cover disk (150) facing the adjustable guide vanes, extends from an inner circumference (112, 152) of the vane bearing ring (110) and/or of the cover disk (152) in the radial direction (24) to a bevel outer radius (R_{A}),
the adjustable guide vanes (120) each having a guide vane trailing edge (123),
the guide vane trailing edge (123) lying in the radial direction (24) in the region of the bevel (200, 200a, 200b) in the case of guide vane positions corresponding to a mass throughput range from a first mass throughput value to a second mass throughput value,
the first mass throughput value being at most 35%.

2. The guide device (100) as claimed in claim 1, the first mass throughput value being at most 30%.

3. The guide device (100) as claimed in claim 1, the second mass throughput value being at least 55%.

4. The guide device (100) as claimed in claim 1, the first mass throughput value being 35% and the second mass throughput value being 55%.

5. The guide device (100) as claimed in claim 1,
a trailing edge radius (R_{L}) being defined between the axial direction (22) and the guide vane trailing edge (123), the trailing edge radius (R_{L}) decreasing with increasingly opening guide vanes, and
the guide vane trailing edge (123) lying in the radial direction (24) in a flow channel, in which the cover disk (150) and the vane bearing ring (110) lie opposite one another in the axial direction (22), in the case of guide vane positions corresponding to the mass throughput range from the first mass throughput value to the second mass throughput value.

6. The guide device (100) as claimed in claim 1,
the vane bearing ring (110) and the cover disk (150) defining a flow channel in which the adjustable guide vanes (120) are arranged,
the flow channel having a flow channel width (Xₛ) which is measured in the axial direction (22) between the vane bearing ring (110) and the cover disk (150),
the flow channel width (Xₛ) being constant between an outer circumference of the vane bearing ring (110) and/or of the cover disk (150) and the bevel outer radius (R_{A}), and
the flow channel width (Xₛ) increasing between the bevel outer radius (R_{A}) and the inner circumference (112, 152) of the vane bearing ring (110) and/or the cover disk (150).

7. The guide device (100) as claimed in claim 1,
the adjustable guide vanes (120) each having a guide vane axis of rotation (PA), the bevel outer radius (R_{A}) being smaller than an axis of rotation radius (R_{PA}) which is measured between the axial direction (22) and the guide vane axis of rotation (PA).

8. The guide device (100) as claimed in claim 1,
the cover disk (150) having the bevel (200a) and the cover disk (150) having an outer radius (RD),
a ratio of the bevel outer radius (R_{A}) to the outer radius (R_{D}) being from 0.60 to 0.859.

9. The guide device (100) as claimed in claim 1,
the vane bearing ring (110) and the cover disk (150) having the bevel (200a, 200b), a bevel angle (α, β) being measured between the facing side (111, 151) and the bevel (200, 200a, 200b), a first bevel angle (α) of the bevel (200a) of the cover disk (150) being greater than a second bevel angle (β) of the bevel (200b) of the vane bearing ring (110), and the first bevel angle (α) being from 0.5°to 5.0.

10. The guide device (100) as claimed in claim 1,
the bevel (200, 200a, 200b) extending completely circumferentially on the facing side (111, 151).

11. A turbine (10) for a supercharging apparatus (1), comprising:
a turbine housing (30),
a turbine wheel (20) which is arranged rotatably in the turbine housing (30), and
a guide device (100) as claimed in claim 1 which is arranged radially outside the turbine wheel (20) in the turbine housing (30) and circumferentially surrounds the turbine wheel (20).

12. The turbine (10) as claimed in claim 11, the turbine housing (30)
having a shoulder (31) for axially and radially mounting the cover disk (150), the shoulder (31) having a ring-shaped, axial projection (31a) which is arranged radially to the inside of the cover disk (150) and forms a radial surface pairing with an inner circumference (152) of the cover disk (150), and
the shoulder (31) having an axial surface (31b) and the cover disk (150) having an axial, disk-shaped extent (154) which is arranged in a radially outer region of the cover disk (150), the axial surface (31b) of the shoulder and the axial, disk-shaped extent (154) forming an axial surface pairing.

13. The turbine (10) as claimed in claim 11, the turbine housing (30) having a shoulder (31) for axially and radially mounting the cover disk (150), the shoulder (31) having a ring-shaped, axial projection (31a) with an end side (31c), and the cover disk (150) having the bevel (200, 200a), the bevel (200, 200a) being flush with the end side (31c) of the shoulder (31) in the axial direction (22) at the inner circumference (152) of the cover disk (150).

14. The turbine (10) as claimed claim 11,
the cover disk (150) having the bevel (200, 200a) and an inner circumferential radius (R_{I1}), the inner circumferential radius (R_{I1}) being equal to or greater than a turbine wheel radius (R_{T}), in ratio of the turbine wheel radius (R_{T}) to the inner circumferential radius (R_{I1}) being from 0.75 to 1.00.

15. A supercharging apparatus (1) for an internal combustion engine or a fuel cell, comprising:
a bearing housing (40),
a shaft (70) which is mounted rotatably in the bearing housing (40),
a compressor (50) with a compressor wheel (52), and a turbine (10) as claimed in claim 11, the turbine wheel (20) and the compressor wheel (52) being coupled to the shaft (70) at opposite ends of the shaft (70) for conjoint rotation.

16. The guide device (100) as claimed in claim 1, the first mass throughput value being at most 20%.

17. The guide device (100) as claimed in claim 1, the first mass throughput value being at most 10%.

18. The guide device (100) as claimed in claim, the second mass throughput value being at least 65%.

19. The guide device (100) as claimed in claim, the second mass throughput value being at least 70%.

20. The guide device (100) as claimed in claim 1, the first mass throughput value being 10% and the second mass throughput value being 70%.
